(19) United States
(12) Patent Application Publication
(10) Pub. No.: US 2016/0082534 A1
(43) Pub. Date: Mar. 24, 2016

(54) METHOD FOR MANUFACTURING A TIPPED CIRCULAR SAW BLADE

(71) Applicant: KANEFUSA KABUSHIKI KAISHA, Niwa-gun, Aichi (JP)

(72) Inventors: Tsugunori Fujiwara, Niwa-gun (JP); Tomoyuki Iinuma, Niwa-gun (JP)

(73) Assignee: KANEFUSA KABUSHIKI KAISHA, Niwa-gun, Aichi (JP)

(21) Appl. No.: 14/786,035

(22) PCT Filed: Jun. 20, 2014
(86) PCT No.: PCT/JP2014/003332

§ 371 Date: Oct. 21, 2015

(30) Foreign Application Priority Data
Jun. 24, 2013 (JP) 2013-131507

(51) Int. Cl. B23D 65/00; B23D 61/04; B23D 61/02

(52) U.S. Cl. CPC B23D 65/00; B23D 61/028; B23D 61/04

(57) ABSTRACT

A method for manufacturing a tipped circular saw blade includes forming a disk-shaped metal base producing cutting edge tips by grinding cutting edges, coating the cutting edge tips with hard coating film, fixing the cutting edge tips coated with the hard coating film to teeth of the metal base by brazing. The hard coating film is of one material selected from a first material including one of nitrides, oxides or oxynitrides containing at least one of Al, Ti, and Cr, a second material including the first material containing at least one of Si, V, Ni, Y, Zr, Nb, Mo, Ta and W, a third material including the first material including at least one of B and C, and a fourth material including the second material containing at least one of B and C.

### TECHNICAL FIELD

The present invention relates to a method for manufacturing a tipped circular saw blade which is formed by fixing cutting edge tips to a disk-shaped metal base by welding and used for cutting a variety of materials such as metal, wood, plastic, and ceramics or other purposes, and particularly to a method for manufacturing a tipped circular saw blade whose cutting edges coated with hard coating film.

### BACKGROUND ART

As an example of a conventional method for manufacturing such a tipped circular saw blade, Japanese Unexamined Patent Application Publication No. H11-239,915 discloses a method for manufacturing a disk-shaped tool comprising brazing tips formed of cemented carbide, cermet, an abrasion-resistant casting alloy or the like to a disk-shaped base plate (a metal base) of steel and then coating the tips by a physical vapor deposition process (hereinafter referred to as a PVD process). In this manufacturing method, steps of producing a disk-shaped base plate, brazing a number of tips to the disk-shaped base plate, grinding the tips, and coating the tips with abrasion-resistant coating film are sequentially carried out. Grinding of the tips after the tips are brazed to the base plate reduces height differences of the large number of tips and secures a highly accurate cutting performance of the disk-shaped tool. This is why production is carried out in the above sequence of steps, and change in the order of steps or simultaneous execution of some of these steps is impossible. As a result, in the above manufacturing method, a sum of production time of each of the four steps is necessary and production costs are high. Besides, production time cannot be drastically reduced.

Moreover, coating of the tips with the abrasion-resistant film is carried out by a PVD process, and in a case of a large-diameter circular saw blade, for example, having an outer diameter of 500 mm or more and a weight of 10 kg or more, a PVD device and a pretreatment device which are large enough for the circular saw blade are necessary. In this way, production of a large-diameter circular saw blade is sometimes restricted by the size of the PVD device. In such a case, it is necessary to prepare a PVD device large enough for the diameter of the circular saw blade, but such a PVD device is very expensive. Therefore, depending on the volume of production, financial burden of device costs is very high. Furthermore, in a case of such a large-diameter circular saw blade, great efforts are necessary to apply coating pretreatment and to place the circular saw blade in devices for coating, so production costs increase even more.

Because, in coating, a disk-shaped base plate is greatly deformed or buckled by a relatively small thermal stress, it is difficult to form a coating film which is good both in film quality and adhesion. That is to say, coating film formation needs to hold a part to be coated at a treatment temperature of several hundreds deg. C, but in such a high-temperature treatment, due to thermal stress caused by non-uniform temperature distribution in the disk-shaped base plate, the disk-shaped base plate undergoes high-temperature plastic deformation, and this deformation remains as distortion. Therefore, the disk-shaped base plate cannot be subjected to a high-temperature treatment. On the other hand, if a coating treatment is applied so as not to cause distortion, then a coating film with good quality and adhesion cannot be obtained. Once residual distortion thus occurs in a disk-shaped base plate, correction of the distortion is almost impossible or takes so much efforts, so the disk-shaped base plate cannot be put in practical use. It has been confirmed that such distortion is likely to occur when a disk-shaped base plate has a relatively small base plate thickness t [mm] with respect to a diameter D [mm]. A problem occurs when a disk-shaped base plate has a thickness t of 3.7×(1/10⁵)×D² [mm] or less.

Moreover, in the above production method, the hard coating film is coated on vicinities of the tips after the tips are welded to the disk-shaped base plate by brazing or the like. Therefore, coating treatment temperature needs to be lower than brazing temperature and accordingly, a restriction is imposed on characteristics of the hard coating film such as heat resistance, durability and abrasion resistance. Moreover, it is impossible to employ a coating method which uses a higher coating treatment temperature than brazing temperature, such as a chemical vapor deposition process (hereinafter referred to as a CVD process).

### SUMMARY OF INVENTION

### Technical Problem

The present invention has been made to solve these problems. It is an object of the present invention to provide a manufacturing method capable of reducing production time for producing a tipped circular saw blade having cutting edge tips fixed by welding to teeth formed on a disk-shaped metal base and having cutting edges coated with hard coating film, and capable of providing a tipped circular saw blade having good heat resistance, durability and abrasion resistance at low costs.

### Solution to Problem

In order to attain the above object, the present invention has the following constituent features. A method of the present invention comprises a first step of forming a disk-shaped metal base of steel, a second step of producing cutting edge tips, a third step of coating at least cutting edges of the cutting edge tips with hard coating film, and a fourth step of fixing the cutting edge tips coated with the hard coating film by welding to teeth formed on the metal base, the hard coating film being of one material selected from the group consisting of a first material comprising one of nitrides, oxides and oxynitrides containing at least one of Al, Ti, and Cr, a second material comprising the first material containing at least one of Si, V, Ni, Y, Zr, Nb, Mo, Ta and W, a third material comprising the first material containing at least one of B and C, and a fourth material comprising the second material containing at least one of B and C.

It should be noted that the hard coating film can be of a first material comprising one of 21 kinds of materials which are AlN, TiN, CrN, AlTiN, AlCrN, TiCrN, and AlTiCrN as nitrides of Al, Ti, Cr, AlTi, AlCr, TiCr, and AlTiCr; AlO, TiO, CrO, AlTiO, AlCrO, TiCrO, and AlTiCrO as oxides of Al, Ti, Cr, AlTi, AlCr, TiCr, and AlTiCr; and AlNO, TiNO, CrNO, AlTiNO, AlCrNO, TiCrNO, and AlTiCrNO as oxynitrides of Al, Ti, Cr, AlTi, AlCr, TiCr, and AlTiCr. However, upon appropriately selecting the second material, the third material or the fourth material, which are based on the first material, in accordance with characteristics of a material to be cut, a circular saw blade attains suitable heat resistance, abrasion resistance, durability, etc. for the material to be cut and can exhibit appropriately improved cutting performance. Examples of a welding method include brazing, resistance welding, welding by irradiation of a high-energy beam such as a laser beam.

In the present invention constructed as mentioned above, the first step can be carried out independently of the second step and the third step, and the cutting edge tips coated with the hard coating film produced in the second step and the third step can be fixed by welding in the fourth step to the teeth of the metal base formed in the first step. As a result, in the present invention, production time can be drastically reduced and production management is facilitated, so production costs of the circular saw blade can be reduced when compared to in a conventional production method. Moreover, in the present invention, the cutting edge tips which have been ground and coated with the hard coating film are welded to the metal base. Therefore, the size of a coating device for forming hard coating film and the size of a pretreatment device are irrelevant to the size of the diameter of the circular saw blade. Therefore, in the present invention, production of the circular saw blade is achieved regardless of the size of the diameter. Besides, since the coating device and the like do not need to be particularly large-scale expensive ones, excessively great equipment investment in these devices are not necessary.

Moreover, in the present invention, the third step of coating the cutting edges of the cutting edge tips with the hard coating film can be carried out before the fourth step of fixing the cutting edge tips coated with the hard coating film by welding to the teeth formed on the metal base. Therefore, temperature for forming the hard coating film can be higher than welding temperature and as a result, cutting edge tips having good heat resistance, durability and abrasion resistance can be obtained.

Additionally, in the present invention, preferably, the hard coating film has an oxidation starting temperature of 800 deg. C or more. With an oxidation starting temperature of 800 deg. C or more, the hard coating film is suppressed from degrading in a brazing step and as a result, the hard coating film appropriately secures heat resistance, durability and abrasion resistance of the cutting edge tips. Oxidation starting temperature is measured by differential scanning calorimetry.

Furthermore, in the present invention, the hard coating film can be formed by a PVD process. Since a PVD device accommodates not the circular saw blade in itself but the cutting edge tips, the PVD process can be suitably employed.

In addition, in the present invention, preferably, part of both side faces of each one of the cutting edge tips are provided with parts parallel to each other, or parts slanted to depart from each other as they go in an opposite direction to a cutting edge of the cutting edge tip. When part of both non-parallel side faces of each one of the cutting edge tips having a radial clearance angle and a tangential clearance angle are provided with faces parallel to each other and the cutting edge tip is pressed against and welded to the tooth, the cutting edge tip can be stably clamped by the parallel faces and therefore can be pressed against the tooth with a high positioning accuracy. On the other hand, when part of both the non-parallel side faces are provided with parts slanted to depart from each other as they go in an opposite direction to a cutting edge of the cutting edge tip, the cutting edge tip clamped by the slanted parts is strongly pressed toward the tooth and therefore can be pressed against the tooth with a high positioning accuracy. As a result, in the present invention, the cutting edge tip can be welded to the tooth with high accuracy, and a circular saw blade having minimum height differences of the plurality of tips, that is to say, the circular saw blade with a high cutting performance can be produced with ease. It should be noted that even if the tips are not coated by omitting the third step, similar effects to the abovementioned ones can be obtained in the present invention.

Furthermore, in the present invention, the base metal can have a thickness of 3.7×(1/10⁵)×D² [mm] or less, where D is a diameter [mm] of the base metal. Since the metal base in itself is not held at a coating treatment temperature of about several hundreds deg. C in the present invention, even a metal base having a small thickness of 3.7×(1/10⁵)×D² [mm] or less does not suffer from residual strain caused by high-temperature plastic deformation. Therefore, rigidity of the base metal can be appropriately secured.

In the present invention, the first step can be carried out independently of the second step and the third step, and then the fourth step can be carried out. Therefore, production time can be drastically reduced and production costs can be reduced when compared to those of a conventional production method. Moreover, in the present invention, hard coating film can be formed by employing a PVD process regardless of the size of the circular saw blade. Furthermore, since the third step of coating the cutting edges of the cutting edge tips with the hard coating film can be carried out before the fourth step of fixing the cutting edge tips coated with the hard coating film by welding to the teeth formed on the metal base, temperature for forming the hard coating film can be higher than welding temperature and as a result, the circular saw blade with highly heat-resistant, durable, and abrasion-resistant cutting performance can be obtained. Moreover, parts of both non-parallel side faces of each one of the cutting edge tips having a radial clearance angle and a tangential clearance angle can be provided with parts parallel to each other or slanted parts. Therefore, when the cutting edge tip is pressed against and welded to the tooth, the cutting edge tip can be pressed against the tooth with a high positioning accuracy. As a result, the circular saw blade having minimum height differences of the plurality of tips, that is, the circular saw blade with a high cutting performance can be obtained.

### BRIEF DESCRIPTION OF DRAWINGS

FIG. 1 is a schematic front view of a tipped circular saw blade according to an example of the present invention.

FIG. 2 is a partially enlarged front view showing part of a metal base of the tipped circular saw blade to which cutting edge tips are brazed.

FIG. 3 is a partially enlarged front view showing part of the metal base before the cutting edge tips are fixed to the metal base by brazing.

FIGS. 4(a), 4(b), and 4(c) are a plan view, a left side view and a front view of a cutting edge tip (a hard coating film not shown), respectively.

FIGS. 5(a), 5(b), and 5 (c) are a plan view, a left side view and a front view of a cutting edge tip according to Modified Example 1, respectively.

FIGS. 6(a), 6(b), and 6(c) are a plan view, a left side view and a front view of a cutting edge tip according to Modified Example 2, respectively.

FIGS. 7(a), 7(b), and 7(c) are a plan view, a left side view and a front view of a cutting edge tip according to Modified Example 3, respectively.

FIGS. 8(a), 8(b), and 8(c) are a plan view, a left side view and a front view of a cutting edge tip according to Modified Example 4, respectively.

FIG. 9 is a schematic front view of a tipped circular saw blade produced by a conventional manufacturing method.

FIG. 10 is a partially enlarged front view of the tipped circular saw blade shown in FIG. 9.

FIGS. 11(a), 11(b), 11(c) are a plan view, a left side view and a front view of a conventional cutting edge tip, respectively.

### DESCRIPTION OF EMBODIMENTS

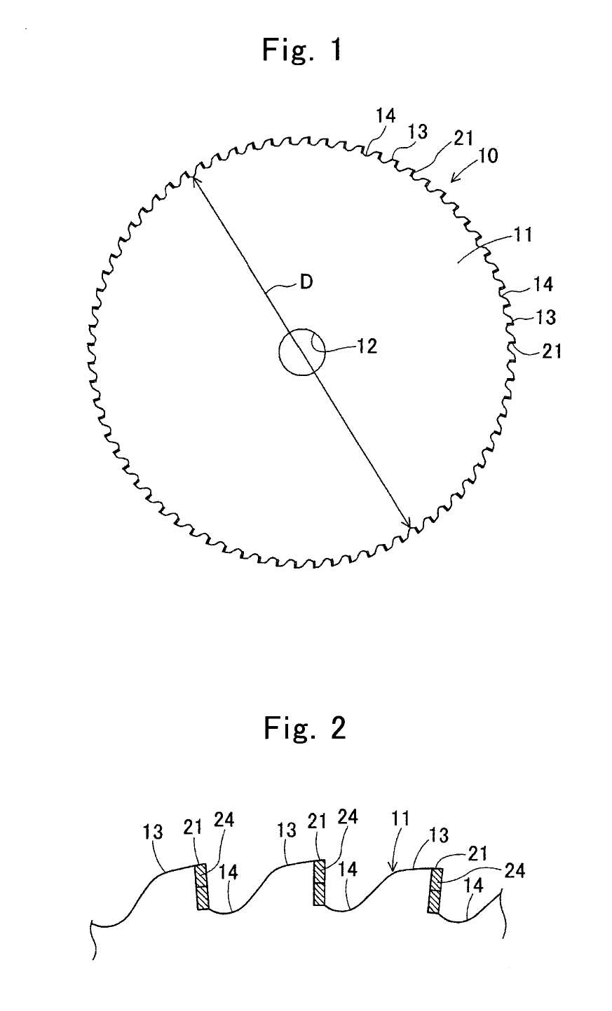

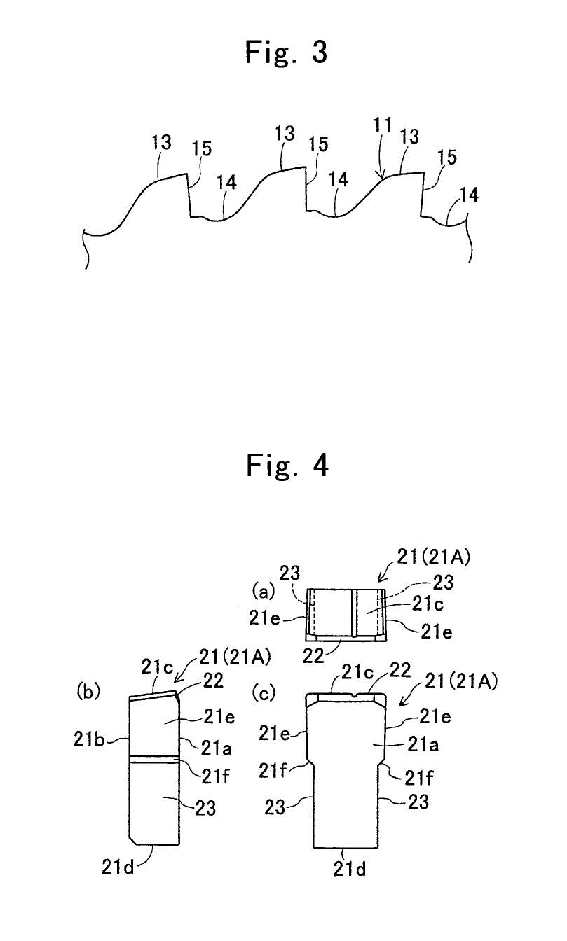

Hereinafter, embodiments of the present invention will be described with reference to drawings. FIG. 1 is a front view of a tipped circular saw blade (hereinafter referred to as a circular saw blade) 10 according to an example. FIGS. 2 and 3 are partially enlarged front views of the circular saw blade 10 and a metal base 11. The metal base 11 constituting the circular saw blade 10 is a thin disk-shaped plate of steel, and has a central hole 12 into which a rotary shaft of machining equipment is inserted. At an outer periphery of the metal base 11, a number of roughly quadrangular teeth 13 protrude radially at circumferentially even intervals, and gullets 14 relatively recede radially between the teeth 13. On a leading edge side of the teeth 13 in a forward direction of rotation, a number of mounting seats 15 are formed by being cut out at a roughly right angle for mounting cutting edge tips 21.

The cutting edge tips 21 are welded on the mounting seats 15 by brazing or the like. As shown in FIG. 4, each one of the cutting edge tips 21 is formed of a hard material such as cemented carbide and has an elongated roughly rectangular parallelepiped shape body which can be in close contact with a mounting seat 15. In the cutting edge tip 21, a front face (a second rake face) 21a and a rear face 21b are parallel to each other, an upper face (a flank face) 21c is a surface slanted at a top clearance angle, and a bottom face 21d forms a right angle with the front face 21a. A cutting edge 22 is formed between the upper face 21c and a first rake face or rake faces located at both ends of the first rake face. Both side faces 21e of the cutting edge tip 21 extending in a width direction of the cutting edge tip 21 have parts which are slanted at a predetermined radial clearance angle in a direction from the upper face 21c toward the bottom face 21d, stepped parts 21f which are located at intermediate positions and slightly recede in the width direction, and parallel parts 23 which extend from the stepped parts 21f toward the bottom face 21d and are parallel to each other.

After the abovementioned outer shape is formed by grinding, the cutting edge tip 21 is brazed on the mounting seat 15. The cutting edge tip 21 has a hard coating film 24 of AlTiCrN having good heat resistance, durability and abrasion resistance as a first material and formed by a cathode arc PVD process, which is a PVD process. The hard coating film 24 is not shown in FIG. 4. The hard coating film 24 formed on the rear face 21b and the bottom face 21d, which are surfaces to be welded on the mounting seat 15 at the time of brazing, is removed by grinding in order to increase welding strength after the hard coating film 24 is formed. Removal of the hard coating film 24 can also be carried out by shot blasting, etc. Formation of the hard coating film 24 on faces of the cutting edge tip 21 which do not need to be coated can be prevented by masking only these faces in forming the hard coating film 24.

Next, a method for manufacturing a circular saw blade according to this example will be described.

The metal base 11 is formed by cutting an ordinary steel plate or the like, for example, so as to have an outer diameter of 750 mm, a thickness of 3.2 mm and seventy-two teeth 13 (a first step). Independently of formation of the metal base 11, as shown in FIG. 4, the cutting edge tips 21 are formed as grinding tips 21A having an elongated roughly rectangular parallelepiped shape and a thickness of 4.8 mm by using a grinding machine (a second step). This grinding machine is used for grinding cutting edge tips as simple bodies, and therefore, does not need to be a large-scale one, unlike a conventional machine for grinding cutting edge tips mounted on the metal base 11. Besides, although it is compact, this grinding machine can grind cutting edge tips of circular saw blades with different outer diameters.

Next, the grinding tips 21A formed by grinding are coated with the hard coating film 24 comprising AlTiCrN by using a cathode arc PVD device (a third step). After the hard coating film 24 is formed, the hard coating film 24 formed on the rear faces 21b and the bottom faces 21d, which are surfaces to be joined with the mounting seats 15 at the time of brazing, is removed by grinding. The cutting edge tips 21 are fixed on the mounting seats 15 formed on the teeth 13, respectively, by brazing using a silver solder alloy or the like (a fourth step). In brazing, while parallel parts 23 are pinched by a clamping tool not shown from both sides, each one of the cutting edge tips 21 is pressed against and brazed to a tooth 13. Owing to this, the large number of cutting edge tips 21 are placed on the mounting seats 15 with a high positioning accuracy. Therefore, height differences of the respective cutting edge tips 21 are kept small, and the circular saw blade 10 with a high cutting performance is provided.

As described above, in this example, the first step of forming the metal base 11 can be carried out independently of the second step of forming an outer shape of the cutting edge tips 21 and the third step of coating the cutting edge tips 21 with the hard coating film 24. The cutting edge tips 21 coated with the hard coating film 24 produced in the second step and the third step can be fixed by brazing in the fourth step on the mounting seats 15 of the metal base 11 formed in the first step. As a result, in this example, production time can be drastically reduced and production management is facilitated, so production costs of the circular saw blade 10 can be reduced when compared to in a conventional method.

Moreover, in this example, the cutting edge tips 21 ground and coated with the hard coating film 24 in the second step and the third step are fixed by brazing on the mounting seats 15 of the teeth 13 in the fourth step. Therefore, the size of a PVD device for forming the hard coating film 24 and the size of a pretreatment device are irrelevant to the size of the diameter of the circular saw blade 10. Accordingly, in this example, the circular saw blade 10 can be produced regardless of the size of the diameter. In addition, the PVD device and the like do not need to be especially large-scale expensive ones, so excessively high investment in these devices is not necessary. Moreover, in this example, in coating the grinding tips 21A with the hard coating film 24, the PVD device needs to accommodate not the circular saw blade 10 in itself but only the grinding tips 21A, and can perform coating treatment on a large number of tips. Therefore, efforts for pretreatment of the metal base 11 and placement of the PVD device are drastically reduced. Accordingly, formation of the hard coating film 24 is even more facilitated and work efficiency in forming the hard coating film 24 is increased. As a result, production costs are further reduced.

Moreover, in this example, the third step of coating the cutting edge tips 21 with the hard coating film 24 can be carried out before the fourth step of fixing the cutting edge tips 21 coated with the hard coating film 24 on the mounting seats 15 by brazing. Therefore, temperature for forming the hard coating film 24 can be higher than brazing temperature, and accordingly, the circular saw blade 10 having the cutting edge tips 21 with high heat resistance, durability, and abrasion resistance can be obtained. Moreover, having good heat resistance and the like, the hard coating film 24 can reduce adverse thermal effect of brazing temperature on the cutting edge tips 21. Moreover, in this example, the hard coating film 24 has an oxidation starting temperature of 800 deg. C or more and can exhibit high performance with high heat resistance, durability and abrasion resistance, so the hard coating film 24 secures heat resistance, durability and abrasion resistance of the cutting edge tips 24. Moreover, since temperature for forming the hard coating film 24 can be higher than brazing temperature, the hard coating film 24 can be formed by using a CVD process or other film forming processes employing high treatment temperature instead of the PVD process. If coating film is formed by a CVD process after brazing in a conventional case, a metal base is deformed and a produced circular saw blade cannot be put in commercial use.

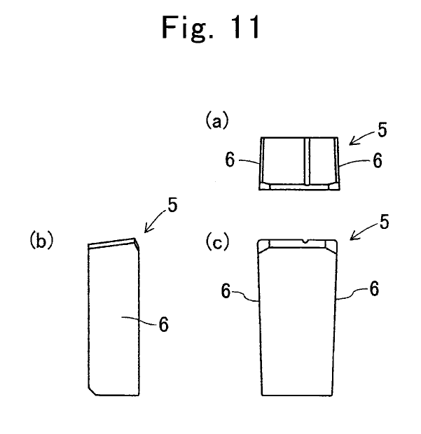

Moreover, in this example, in brazing, while parallel parts 23 are pinched by a clamping tool not shown from both sides, each one of the cutting edge tips 21 is pressed against and brazed to the tooth 13. Owing to this, the cutting edge tip 21 is placed on amounting seat 15 with a high positioning accuracy. Therefore, height differences of the respective cutting edge tips 21 are kept small and the circular saw blade 10 with a high cutting performance is provided. If entire side faces 6 are slanted at a predetermined radial clearance angle and also at a tangential clearance angle in a thickness direction as in a conventional cutting edge tip 5 shown in FIG. 11, the cutting edge tip 5 cannot be stably clamped by a clamping tool, and therefore a variation arises in pressing the cutting edge tip 5 against a mounting seat. As a result, height differences of a great number of cutting edge tips 5 may be remarkably great and cutting performance of a circular saw blade 1 as produced may be impaired. Therefore, if the conventional cutting edge tip 5 is employed in this example, corrective processing is necessary after the tip 5 is brazed to the tooth 13. In this example, however, height differences of the cutting edge tips 21 after welded are kept sufficiently small, so grinding work after welding is not necessary.

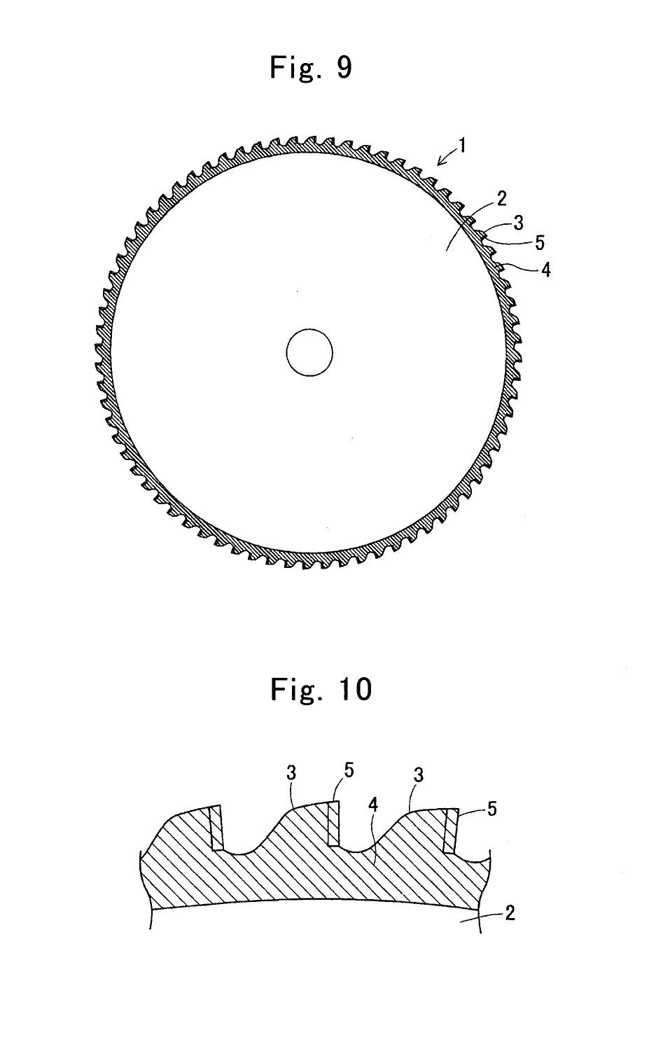

Moreover, in this example, only the cutting edge tips 21 are coated with the hard coating film 24, as shown in FIGS. 1 and 2. Therefore, outer appearance is great when compared to that of the conventional circular saw blade 1 in which hard coating film 4 is formed in an annular shape so as to include teeth 3 located at an outer periphery of a metal base 2 and cutting edge tips 5 welded to the teeth 3, as shown in FIGS. 9 and 10. Besides, in this example, the metal base 11 in itself is not coated with the hard coating film 24, or held at a coating treatment temperature of about several hundreds deg. C. Therefore, even a metal base 11 having a large outer diameter D of 750 mm can have a small thickness of about 3.7×(1/10⁵)×D² [mm] or less, e.g., about 3.2 mm. Even when the metal base 11 has a small thickness of 3.2 mm, rigidity of the base metal 11 can be appropriately secured because distortion due to high-temperature plastic deformation does not remain in the metal base 11. Moreover, in this example, edge sharpening of the cutting edge tips 21 by using a grinding stone is not carried out after the cutting edge tips 21 are brazed to the metal base 11. Therefore, there is no risk that grinding stone mark left on the metal base 11 may harm outer appearance or performance of the metal base 11.

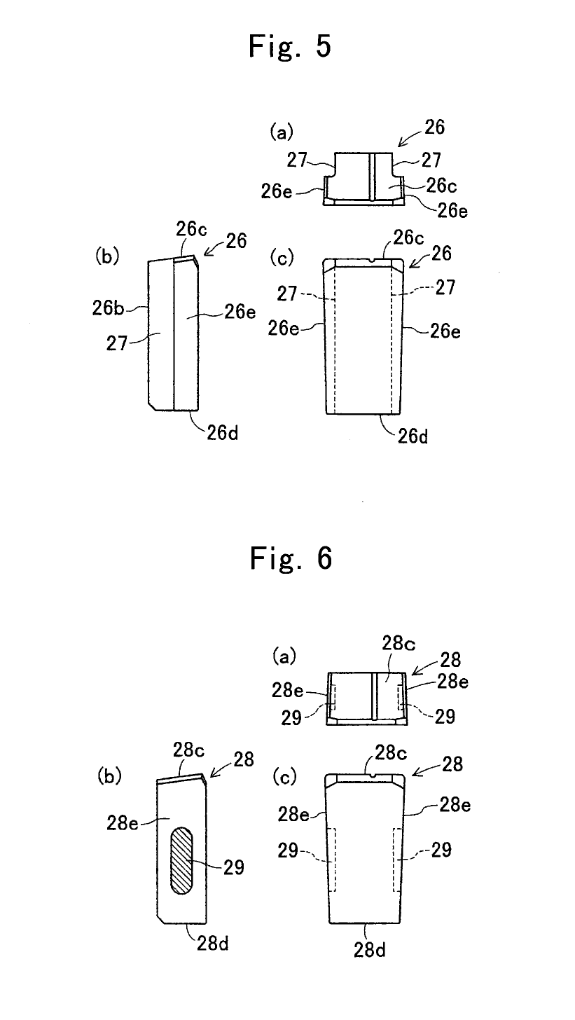

Next, cutting edge tips 26 according to Modified Example 1 will be described with reference to FIG. 5. Each one of the cutting edge tips 26 has almost the same outer shape as those of the abovementioned cutting edge tips 21, but both side faces 26e are slanted at a predetermined radial clearance angle in a direction from an upper face 26c toward a bottom face 26d. Furthermore, part of both the side faces 26e between intermediate positions in a thickness direction and a rear face 26b are parallel parts 27 which slightly recede in a width direction and are parallel to each other. While the parallel parts 27 are tightly pinched by a clamping tool not shown from both sides, the cutting edge tip 26 is pressed against and brazed to a tooth 13. As a result, also in Modified Example 1, the cutting edge tip 26 is placed on a mounting seat 15 with a high positioning accuracy, so height differences of the respective cutting edge tips 26 are kept small and the circular saw blade 10 with a high cutting performance is provided.

Next, cutting edge tips 28 according to Modified Example 2 will be described with reference to FIG. 6. Each one of the cutting edge tips 28 has almost the same outer shape as those of the abovementioned cutting edge tips 26 and both entire side faces 28e are slanted at a predetermined radial clearance angle as they go from an upper face 28c toward a bottom face 28d. Moreover, part of both the side faces 28e at intermediate positions between the upper face 28c and the bottom face 28d are provided with parallel recessed parts 29 which are recessed in the shape of a hole elongated in a direction connecting the upper face 28c and the rear face 28d and which have recessed faces in parallel to each other. While the parallel recessed parts 29 are tightly pinched by a clamping tool not shown from both sides, the cutting edge tip 28 is pressed against and brazed to a tooth 13. As a result, also in Modified Example 2, the cutting edge tip 28 is placed on a mounting seat 15 with a high positioning accuracy, so height differences of the respective cutting edge tips 28 are kept small and the circular saw blade 10 with a high cutting performance is provided.

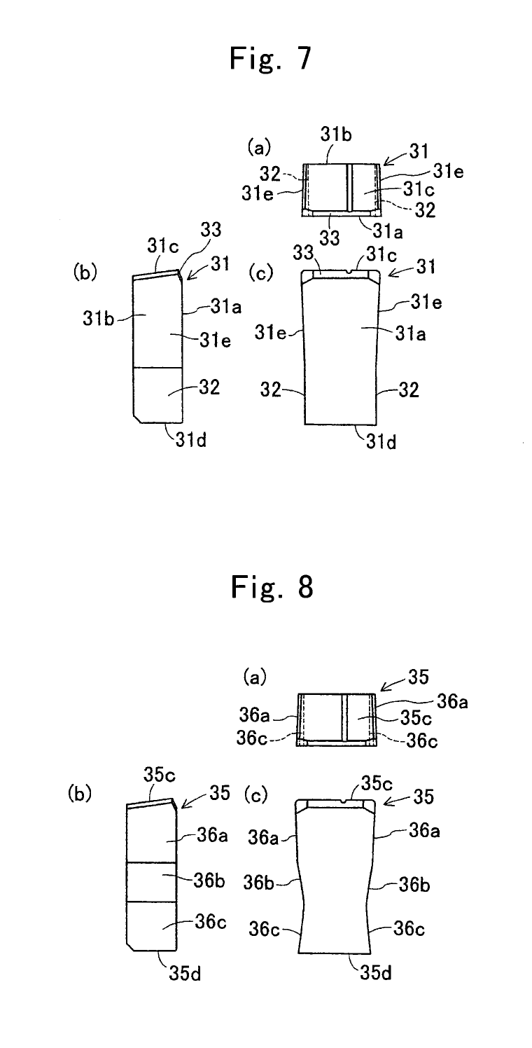

Next, cutting edge tips 31 according to Modified Example 3 will be described with reference to FIG. 7. Each one of the cutting edge tips 31 has a similar outer shape to those of the abovementioned cutting edge tips 21 and part of both side faces 31e between an upper face 31c and intermediate positions of the upper face 31c and a bottom face 31d are slanted at a predetermined radial clearance angle. Moreover, both the side faces 31e are slanted from a front face 31a toward a rear face 31b at a predetermined tangential clearance angle. Part of both the sides faces 31e between the intermediate positions and the bottom face 31d are slanted parts 32 which are slanted in an opposite direction to the radial clearance angle, that is, to depart from each other as they go in an opposite direction to a cutting edge 33.

When the cutting edge tip 31 is provided with these slanted parts 32 and clamped by a clamping tool not shown by the slanted parts 32 and pressed toward a mounting seat 15, because the slanted parts 32 have inclinations in an opposite direction to a pressing direction, the clamping tool is firmly engaged with the slanted parts 32. Therefore, since the cutting edge tip 31 is strongly pressed against the mounting seat 15, the cutting edge tip 31 can be pressed against a tooth 13 with a high positioning accuracy. As a result, in Modified Example 3 as well as the above examples, the cutting edge tip 31 can be brazed to the tooth 13 while placed with a high positioning accuracy, so height differences of a large number of cutting edge tips 31 are suppressed to minimum and a circular saw blade with a high cutting performance is provided with ease.

Next, cutting edge tips 35 according to Modified Example 4 will be described with reference to FIG. 8. Each one of the cutting edge tips 35 has a similar outer shape to those of the above cutting edge tips 31, but both sides are divided into three sections of first side parts 36a, second side parts 36b and third side parts 36c located in this order in a direction from an upper face 35c toward a bottom face 35d. The first side parts 36a are slanted at a predetermined radial clearance angle. The second side parts 36b connected to the first side parts 36a are slanted at a slightly larger angle than the radial clearance angle in the same direction. The third side parts 36c are slanted to widen in opposite directions to the directions of the inclinations of the second side parts 36b in terms of a width direction.

When the cutting edge tip 35 is provided, on a side of the bottom face 35d, with the third side parts 36c which depart from each other as they go in opposite directions to the first side parts 36a and the second side parts 36b and clamped by a clamping tool not shown by the third side parts 36c and pressed toward the mounting seat 15, the third side parts 36c have inclinations in an opposite direction to a pressing direction. Therefore, the clamping tool is firmly engaged with the third side parts 36c and strongly presses the cutting edge tip 35 against the mounting seat 15, so the cutting edge tip 35 is brazed while pressed against the tooth 13 with a high positioning accuracy. As a result, in Modified Example 4 as well as Modified Example 3, the cutting edge tip 35 can be brazed while placed with a high positioning accuracy, so height differences of a large number of cutting edge tips 35 are suppressed to minimum and a circular saw blade with a high cutting performance is provided with ease.

In the above examples, the production methods including the first to fourth steps have been described. However, the third step of coating at least cutting edges of cutting edge tips with hard coating film can be omitted, if necessary. Even when the third step is omitted and the cutting edge tips are not coated with the hard coating film, similar advantageous effects to those described above can be obtained.

It should be noted that in the above examples, the material of the cutting edge tips is not limited to cemented carbide, and can be cermet, high-speed steel, Stellite, various kinds of ceramics, etc. The cutting edge tips can be ground, left as it is after sintered, or treated with shot blasting. Moreover, although AlTiCrN is employed as hard coating film in the examples, a material can be appropriately selected with use of a circular saw blade from the abovementioned first, second, third and fourth materials. Furthermore, although the cutting edge tips are welded by brazing in the examples, resistance welding, high-power beam welding such as laser welding, etc. can be employed instead of brazing. The abovementioned examples are just examples and various modifications may be made without departing from the spirit of the present invention.

1. A method for manufacturing a tipped circular saw blade, comprising a first step of forming a disk-shaped metal base of steel, a second step of producing cutting edge tips, a third step of coating at least cutting edges of the cutting edge tips with hard coating film, and a fourth step of fixing the cutting edge tips coated with the hard coating film by welding to teeth formed on the metal base, the hard coating film being of one material selected from the group consisting of a first material comprising one of nitrides, oxides and oxynitrides containing at least one of Al, Ti, and Cr, a second material comprising the first material containing at least one of Si, V, Ni, Y, Zr, Nb, Mo, Ta and W, a third material comprising the first material containing at least one of B and C, and a fourth material comprising the second material containing at least one of B and C.

2. The method for manufacturing a tipped circular saw blade according to claim 1, wherein the hard coating film has an oxidation starting temperature of 800 deg. C or more.

3. The method for manufacturing a tipped circular saw blade according to claim 2, wherein the hard coating film is coated by a physical vapor deposition process.

4. The method for manufacturing a tipped circular saw blade according to claim 1, wherein part of both side faces of each one of the cutting edge tips are provided with parts parallel to each other, or parts slanted to depart from each other as they go in an opposite direction to a cutting edge of the cutting edge tip.

5. The method for manufacturing a tipped circular saw blade according to claim 1, wherein the base metal has a thickness of 3.7×(1/10⁵)×D² [mm] or less, where D is a diameter [mm] of the base metal.

6. The method for manufacturing a tipped circular saw blade according to claim 1, wherein the third step is omitted.
